(19) United States
(12) Patent Application Publication
(10) Pub. No.: US 2005/0089605 A1
(43) Pub. Date: Apr. 28, 2005

(54) Greeting card for mailing a consumable product or the like

(76) Inventors: Sebastian Siethoff, Chicago, IL (US); Robert W. Anderson, Chicago, IL (US)

Correspondence Address: BELL, BOYD & LLOYD LLC, P. O. BOX 1135, CHICAGO, IL, 60690-1135, US

(21) Appl. No.: 10/697,813

(22) Filed: Oct. 28, 2003

(51) Int. Cl. C12C 1/027

(52) U.S. Cl. 426/106

(57) ABSTRACT

The present invention provides a greeting card for mailing at least one consumable product to a recipient and a method for mailing consumable products, especially chewing gum. The package includes a housing including a location for postage and at least one location for an address, where the housing encloses the chewing gum. The package also includes a cover hingedly attached to the housing wherein the cover is movable to reveal information included on the housing to the recipient. Information may also be included on the outside surface of the cover. The information may be a text message such as a greeting, an image or the like. In an embodiment, the housing is inserted into a sleeve to protect and secure the housing.

### BACKGROUND OF THE INVENTION

The present invention relates generally to greeting cards. More particularly, the present invention relates to a greeting card for mailing consumable products.

The packaging for consumable or confectionery products is very important to the look, marketing and storage of the product. Very often, in addition to text on the packaging, the packaging also attempts to visually convey a message about the type of product, the taste of the product or the purpose of the product. For example, packages for cinnamon or cherry tasting products are often red, grape tasting product packaging is often purple, etc. Once the consumer has identified a desired brand, the consumer can typically choose a product based solely on the color of the packaging.

In marketing the product, packaging can convey other information besides taste. Namely, products are often displayed in packaging including different colors or images, which convey a theme or themes to a consumer. For example, the packaging may be in the shape of a candy cane during the Christmas season. Moreover, the packaging may include red and green colors and/or images of Santa Claus, wreaths and the like to convey the Christmas theme.

In addition to creating attractive packaging, several different marketing methods are used to promote products. One known marketing method is the mailing of a product or products to potential consumers. These mailings enable product manufacturers to send a sample or samples of their product to a large number of consumers.

Typically, these mailings include promotional material such as flyers, coupons or other incentive materials, which further promote the product to consumers. The promotional material is generally mailed loosely in the product packaging. Because the promotional material is mailed loosely, the promotional material tends to fall out of the packaging when the packaging is opened or thereby gets separated from the product and/or the product packaging. As a result, the promotional material may be lost which eliminates the benefit of sending the promotional material.

Because marketing significantly affects the success and sales of products, there is a need for different mailing packages for products that are attractive to consumers and promote and sell the products. Additionally, there is a need for product packages that are durable for mailing. There is also an additional need for product packages which maintain promotional material with the product contained in the package.

It is therefore desirable to provide a greeting card for mailing consumable products to consumers which conveys a message to the consumers.

It is also desirable to provide a package that is durable and protects consumable products during mailing.

It is also desirable to provide a package for mailing consumable products to consumers which maintains information for consumers.

### SUMMARY OF THE INVENTION

The present invention provides a greeting card for mailing products to a recipient and a method for mailing the products, especially consumable products. More specifically, the present invention provides a greeting card or mailer for mailing consumable products having a housing and at least one cover hingedly connected to the housing. The housing encloses at least one consumable product and includes a location for postage and at least one location for an address. The cover pivots or moves from a substantially closed position to a substantially open position to reveal information to the recipient. The information may be a text message, an image, an audio message, a visual message, an audiovisual message or the like. A recipient receives the greeting card in the mail, grasps the cover and moves the cover to reveal the information such as a greeting under the cover. The information may be related to the consumable product or products, a theme or themes or any other suitable information. In an embodiment, the information is also included or attached to the outside of the cover to convey information such as a greeting to consumers before the consumers open the greeting card.

To this end, in an embodiment, a greeting card for mailing consumable products is provided. The greeting card includes a housing for mailing at least one consumable product including a location for placing postage and at least one location for placing an address. The housing encloses the consumable product and includes a display area having information. The greeting card also includes a cover hingedly connected to the housing. At least a portion of the cover is movable from a substantially closed position adjacent to the housing to a substantially open position away from the housing to display the information included in the display area.

In an embodiment, the housing includes a closed end and an opposing open end.

In an embodiment, at least a portion of the housing is substantially transparent.

In an embodiment, at least a portion of the cover is substantially transparent.

In an embodiment, the information includes at least one text message.

In an embodiment, the information includes at least one image.

In an embodiment, the information includes at least one greeting.

In an embodiment, the display area is removably attached to the housing.

In an embodiment, the open end includes a first lid and a second securing lid hingedly connected to the housing, wherein the first lid is folded and secured to the housing and the second securing lid is folded and secured to a slot defined by the first lid to secure the first lid.

In an embodiment, a second housing is provided where the second housing includes an open end. The housing is removably inserted into the opening of the second housing.

In an embodiment, the second housing is substantially transparent.

In an embodiment, the consumable product is chewing gum.

In another embodiment, a greeting card for mailing consumable products is provided. The greeting card includes a housing defining a receptacle for removably receiving at least one consumable product. The housing also includes a location for postage, at least one location for an address and a first greeting on an outer surface. In addition, the greeting card includes a wall pivotally secured to the housing. The wall includes a second greeting and pivots between an open position and a closed position that conceals the first greeting.

In an embodiment, at least a portion of the wall is substantially transparent.

In an embodiment the first greeting includes at least one of a text message and an image.

In an embodiment, the second greeting includes at least one of a text message and an image.

In an embodiment, a sleeve having opposing walls and at least one open end is provided. The housing is removably inserted into the opening of the sleeve.

In an embodiment at least a portion of the sleeve is substantially transparent.

In a further embodiment, a method for providing a greeting to a recipient is provided. The method includes the step of selecting a card that is so constructed and arranged to receive at least one consumable product. The following step is placing a consumable product in the card. The next step is mailing the card to a recipient. The following step is providing a first greeting when the recipient receives the card. The next step is providing a second greeting when the recipient opens a cover pivotally secured to the card. The following steps are enabling the recipient to remove the consumable product from the card and then enabling the recipient to maintain the card in a substantially planar form after removing the consumable product from the card.

In an embodiment, the step of providing the first greeting includes providing at least one of an audio greeting, a visual greeting and an audiovisual greeting.

In an embodiment, the step of providing the second greeting includes providing at least one of an audio greeting, a visual greeting and an audiovisual greeting.

In an embodiment, the step of providing the first greeting includes providing a seasonal greeting.

In an embodiment, the step of providing the second greeting includes providing a seasonal greeting.

An advantage of the present invention is to provide a greeting card for mailing consumable products to consumers.

Another advantage of the present invention is to provide a durable package which protects and maintains the consumable products during transportation in the mail.

Further, an advantage of the present invention is to provide a greeting card for mailing consumable products that maintains information with the package.

Moreover, an advantage of the present invention is to provide a greeting card for mailing consumable products that promotes the consumable products.

Additionally, an advantage of the present invention is to provide a greeting card for mailing consumable products that includes seasonal greetings.

Additional features and advantages of the present invention will be described in and apparent from the detailed description of the presently preferred embodiments.

### BRIEF DESCRIPTION OF THE FIGURES

FIG. 1 is a perspective view of an embodiment of the greeting card of the present invention.

FIG. 2 is a perspective view of an embodiment of FIG. 1 where a message is displayed on the housing of the greeting card.

FIG. 3 is an exploded perspective view of the embodiment of FIG. 1, where products are being removably inserted into the greeting card.

FIG. 4 is a perspective view of the embodiment of FIG. 3 where the products are fully inserted into the greeting card.

FIG. 5 is an exploded perspective view of an alternative embodiment of FIG. 1 where the greeting card is removably inserted into a second housing.

### DETAILED DESCRIPTION OF THE PRESENTLY PREFERRED EMBODIMENTS

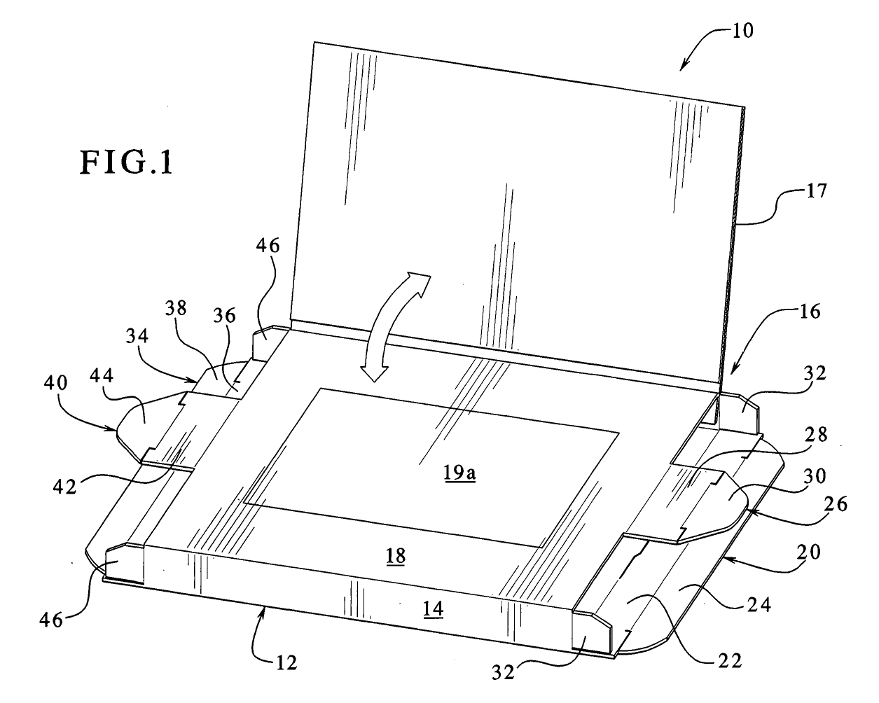

Referring now to the drawings and in particular to FIG. 1, an embodiment of the product mailer or greeting card 10 of the present invention is illustrated. The greeting card 10 in the illustrated embodiment includes a housing 12, which encloses at least one product, and a cover hingedly connected to the housing. The housing includes a location for postage and at least one location for an address to mail the package to one or more recipients. Although the greeting card in a preferred embodiment is designed to be used to house confectionery products, e.g., gum, the greeting card can be used to house other products, e.g., pharmaceuticals.

The housing 12 includes a front wall 14, a rear wall 16, a top wall 18, a bottom wall (not shown), and a cover 17. The front wall 14, rear wall 16, top wall 18 and the bottom wall form the housing. The housing 12 also includes a first lid 20 including a top 22 and a flap 24. The housing further includes side flaps 32. The first lid 20 and more specifically the flap 24 folds over the side flaps 32 to secure the first lid 20 to the housing.

In an embodiment, the housing includes a first securing lid 26 having a top 28 in a flap 30. The first securing lid 26 and more specifically the flap 30 is folded over the first lid 20 and into a slot (not shown) defined by the first lid 20. The first securing lid 26 further secures the first lid 20 to the housing 12 so that any products contained in the housing do not fall out of the housing.

Similarly, at the opposite end of the housing, the housing includes a second lid 34 including a top 36 and a flap 38. The housing also includes second side flaps 46. The flap 38 is folded over the side flaps 46 to secure the second lid 34 to the housing 12. Additionally, the housing includes a second securing lid 40 having a top 42 and a flap 44. The flap 44 is folded over the first lid 34 into a corresponding slot (not shown) defined in the second lid 34.

The housing further includes a cover, wall or door 17 which is hingedly connected or attached adjacent to the rear wall 16 near the top wall 18 of the housing 12. The cover 17 or at least a portion of the cover pivots toward and away from the housing 12 to reveal information displayed by the display area 19. In an embodiment, the cover 17 is integrally formed with the housing 12. In another embodiment, the cover 17 is secured to the housing 12 using a suitable adhesive or the like. In a further embodiment, the cover 17 includes a tab (not shown) which inserts into a corresponding slot (not shown) defined in the top wall 18 of the housing 12. It should be appreciated that any suitable securing device or method may be used to secure the cover 17 to the housing 12.

Although FIG. 1 illustrates the greeting card 10 including two open ends, the present invention may include any suitable number of open ends for receiving products. Additionally, the illustrated embodiment shows cover 17 hingedly attached to the top wall 18 adjacent to the rear wall 16. The cover 17 may be attached to any portion of the housing 12 so that the cover 17 is able to pivot towards and away from the housing.

Additionally, FIG. 1 illustrates greeting card 10 including one cover or door 17 which pivots or moves towards and away from the housing 12. The present invention may also include a plurality of covers 17 which are hingedly connected to the housing 12 where each cover moves towards and away from the housing to reveal information to a consumer. The plurality of covers may be opened independently and in any order.

In an embodiment, the housing 12 includes at least one display area 19a attached to the top wall 18 of the housing 12 and at least one display area 19b attached to the outside surface of the cover 17. The display areas 19a and 19b remain attached or otherwise associated with the housing 12 and the cover 17, respectively, and each displays information to a consumer. The information on display areas 19a and 19b may be information related to a theme or themes such as a seasonal greeting (i.e., a Christmas greeting) or other greeting included in the greeting card 10, information related to the product or products included in the greeting card, or any other suitable information. Additionally, the information may include a text message, an image, an audio message, a visual message, an audiovisual message or any combination thereof. Although the illustrated embodiment shows two display areas 19a and 19b, the greeting card 10 may include one display area such as display area 19a or 19b, or a plurality of display areas to convey information such as a greeting to a consumer. In addition, in accordance with the above embodiment, the number of display areas may be greater than, the same as or less than the number of covers connected to the housing.

In an embodiment, the display area 19b is attached to the outside surface of the cover 17 and the display area 19a is attached to the outside surface of the top wall 18 of the housing 12. Therefore, prior to mailing the greeting card, the door or cover 17 is moved towards the housing and covers or hides the information or greeting displayed in display area 19a. When a recipient such as a consumer receives the greeting card 10, the consumer initially sees the information or greeting attached to the display area 19b. The consumer then lifts or opens the cover 17 and moves or pivots the cover away from the housing 12 to reveal the information or greeting in display area 19a.

In another embodiment, the one or both of the display areas 19a and 19b are removably attached to the housing 12. In this embodiment, the display areas 19a and 19b may be cards, pieces of paper, or any other suitable media which may be attached to and/or removed from the housing 12. For example, a business card or coupon may be attached to one or both of the display areas 19a and 19b to convey information to a recipient.

Although the illustrated embodiment shows display areas 19a and 19b attached to the housing 12 and the cover 17, respectively, the display areas may be attached to the inside surface of the cover 17, the top surface of the cover 17, to the bottom surface of the housing 12 or to any other suitable surface of the housing 12.

In an embodiment, the housing 12 includes a location for postage and at least one location for a recipient's address. For example, the postage and recipient's address may be included on the bottom wall or surface (not shown) of the housing (i.e., the surface opposite to the top wall 18). It should be appreciated that the postage, the recipient's address and/or any other suitable address may be included on the housing 12, the cover 17 or any other suitable location on the greeting card.

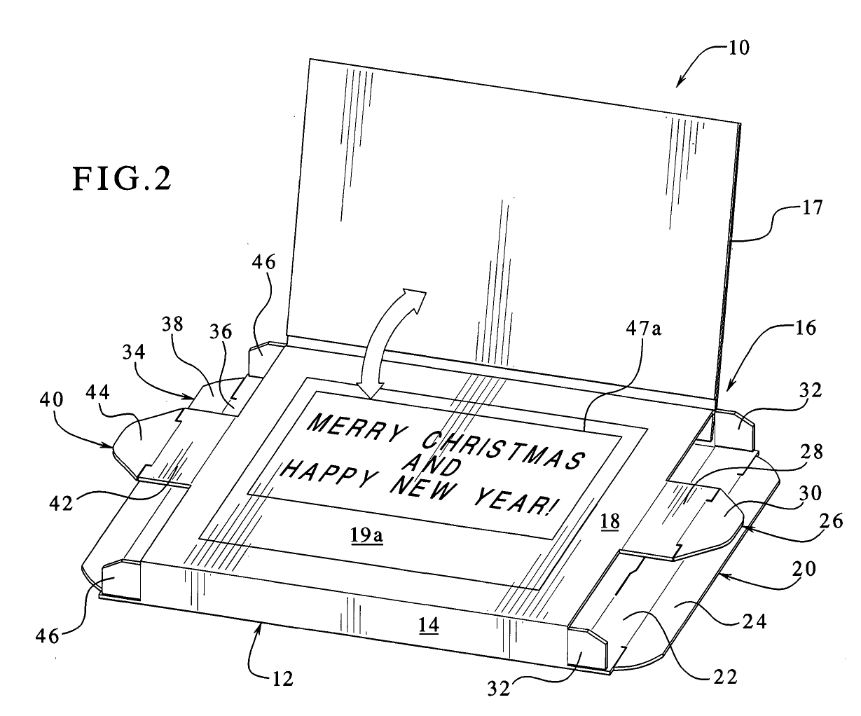

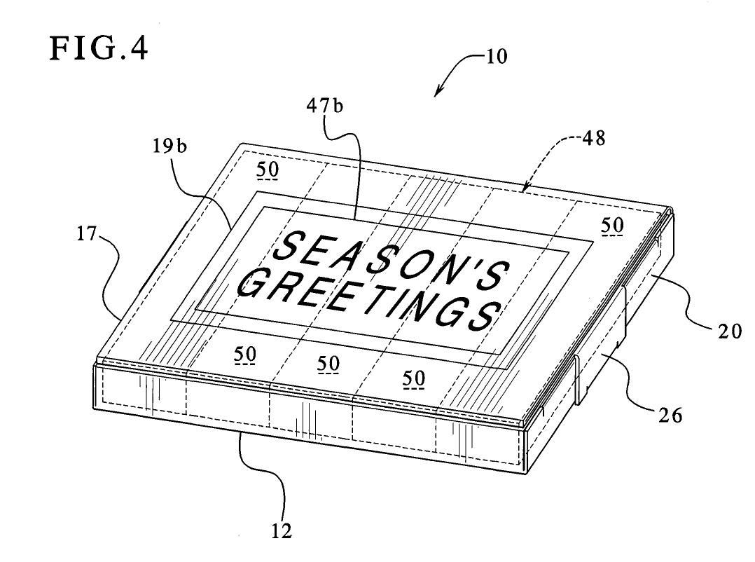

Referring now to FIGS. 2 and 4, an embodiment of the greeting card 10 is illustrated where the display areas 19a and 19b include text messages 47a and 47b such as seasonal greetings. For example, the text message 47a in FIG. 2, displays the words “Merry Christmas and Happy New Year!” and the text message 47b displays the words “Season's Greetings.” Therefore, the text messages 47a and 47b provide greetings relating to the theme of Christmas. The text messages 47a and 47b may be any suitable message or greeting directed to the recipient of the package.

In another embodiment, the display areas 19a and 19b include one or more images (not shown) which convey information to the package recipient. The images may be associated with a text message 47a and/or 47b or any other suitable message. Although the text messages 47a and 47b display words associated with a theme, the text messages may also convey marketing information such as the information included on a coupon or any other information.

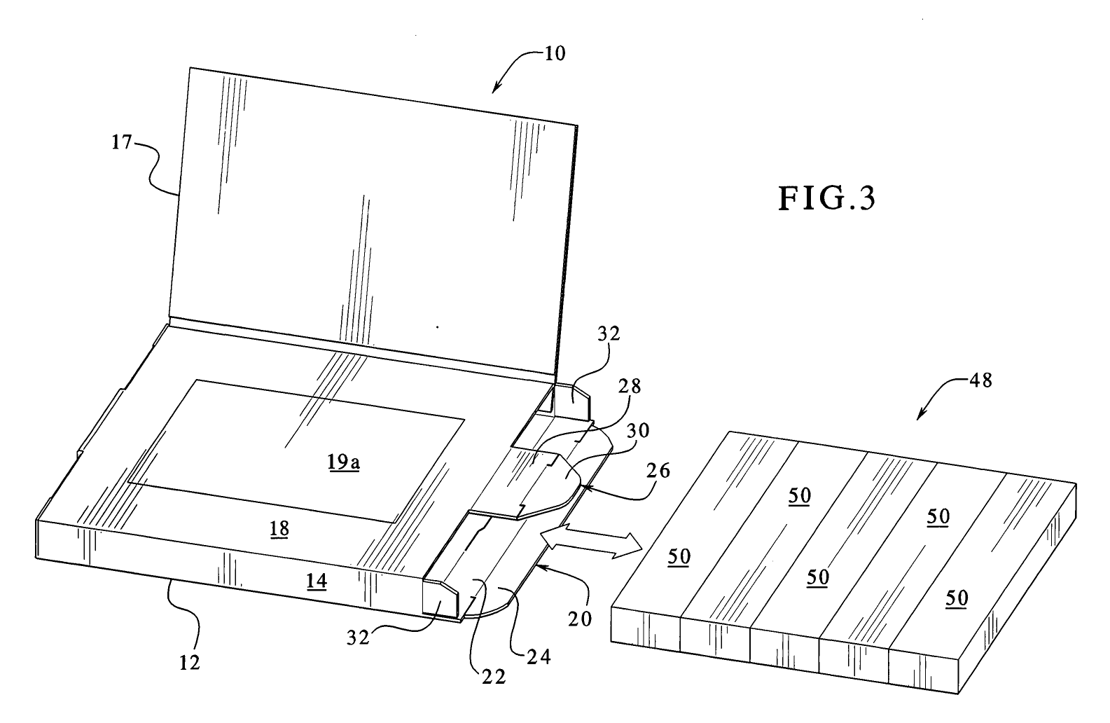

Referring to FIG. 3, a product package 48 including a plurality of consumable products 50 is removably inserted into the housing 12. The product package 48 corresponds to the shape and size of housing 12 and fits into the housing. Next, the flap 24 of the first lid 20 is folded over the first side flaps 32 to secure the first lid 20 to the housing 12. Then, the flap 30 of the first securing lid 26 is folded over the first lid 20 and into a corresponding slot in the first lid 20 to secure the first securing lid 26 to the housing 12.

In FIG. 3, the cover or door 17 is shown in a open position to reveal the display area 19a. Once the product package 48 is inserted to the housing 12, the cover 17 is moved to the closed position adjacent to the top wall 18 of the housing to cover or hide the display area 19a. The cover 17 is then removably secured to the housing 12.

In an embodiment, a manufacturer inserts at least one product such as a consumable product in the product mailer or greeting card 10 and then mails the greeting card to a recipient such as a consumer to promote the consumable product contained in the package.

In another embodiment, the product mailer or greeting card 10 is displayed in a retail location such as a store. For example, the greeting card 10 may be displayed with other greeting cards in the greeting card section of the store. In this embodiment, the greeting card 10 does not include a consumable product or any other product. Instead, the greeting card 10 is displayed in the store in a flat or substantially planar form. A consumer then purchases and constructs and/or folds the greeting card to form a receptacle or cavity for receiving at least one consumable product. After the greeting card is assembled, the consumer inserts their own consumable product or products such as chewing gum into the receptacle or cavity. Then, the consumer transfers or provides the greeting card to a recipient (i.e., a friend, relative, business associate or the like) such mailing the greeting card to the recipient. The recipient reads the greeting on the greeting card and can un-fold or otherwise flatten the greeting card back to its original flat or substantially planar form and display the greeting card such as on a refrigerator, fireplace mantel or any other suitable location.

In an embodiment, the display areas 19a and/or 19b include pre-printed messages such as messages or greetings 47a and 47b. In another embodiment, one or more of the display areas are initially blank or at least partially blank and enable a consumer to include or attach a personal note or greeting to one or more of the display areas.

Referring now to FIG. 4, the greeting card 10 is illustrated where the product package 48 is fully inserted into and secured in the housing 12. As illustrated, the first lid 20 covers the opening of the housing 12 and is secured to the housing. The first securing lid 26 folds over the first lid 20 and is inserted into a corresponding slot in the first lid 20 to further secure the first lid to the housing. The lids 20 and 26 secure the product in the package and prevent the product from falling out of the package during the transportation of the package in the mail. The cover 17 is in the closed position adjacent to the housing 12 so that the information or greeting included in display area 19b is visible to the recipient. However, the cover 17 conceals or hides the information on the display area 19a to prevent this information from being read or damaged prior to being received by the intended recipient. Once the greeting card 10 is received, initially sees the information such as a greeting or image in display area 19b. The recipient the lifts the cover 17 away from the housing 12 by pivoting the cover 17 upward away from the housing. This reveals the information included in display area 19a such as a greeting and/or image to the recipient. This provides a unique method of conveying product, marketing or other suitable information to an intended recipient.

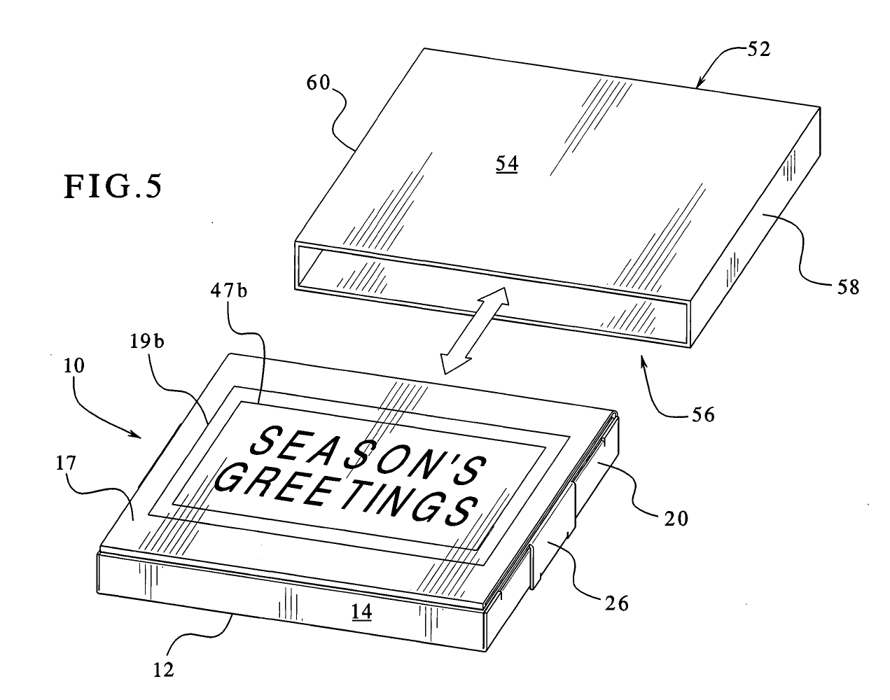

Referring now to FIG. 5, another embodiment of the present invention is illustrated where the housing 12 fits into a second housing or sleeve 52 to further protect the greeting card 10 in the mail. The sleeve also further secures the cover 17 in the closed position so that the cover does not accidentally open in the mail. In an embodiment, the sleeve 52 includes a top wall 54, bottom wall 56, and side walls 58 and 60 that form the sleeve. The sleeve 52 also includes at least one opening corresponding to the size and shape of the greeting card 10 so that the greeting card 10 is removably inserted into the sleeve 52. In an embodiment, the sleeve 52 includes a substantially transparent material. In another embodiment, the sleeve 52 includes a substantially non-transparent material. The sleeve 52 may include images, text, or any combination of text, images, graphics and the like to convey additional information.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A greeting card for mailing consumable products comprising:
a housing for mailing at least one consumable product including a location for placing postage and at least one location for placing an address, said housing enclosing the product;
a display area included on the housing, the display area including information; and
a cover hingedly connected to said housing, at least a portion of the cover being movable from a substantially closed position adjacent to the housing to a substantially open position away from the housing to display the information included in the display area.

2. The greeting card of claim 1, wherein the housing includes a closed end and an opposing open end.

3. The greeting card of claim 1, wherein at least a portion of the housing is substantially transparent.

4. The greeting card of claim 1, wherein at least a portion of the cover is substantially transparent.

5. The greeting card of claim 1, wherein the information includes at least one text message.

6. The greeting card of claim 1, wherein the information includes at least one image.

7. The greeting card of claim 1, wherein the information includes at least one greeting.

8. The greeting card of claim 1, wherein the display area is removably attached to the housing.

9. The greeting card of claim 1, wherein the open end includes a first lid and a second securing lid hingedly connected to the housing, wherein the first lid is folded and secured to the housing and the second securing lid is folded and secured to a slot defined by the first lid to secure the first lid.

10. The greeting card of claim 1, which includes a second housing having an open end, wherein said housing is removably inserted into the opening of the second housing.

11. The greeting card of claim 10, wherein the second housing is substantially transparent.

12. The greeting card of claim 1, wherein the consumable product is chewing gum.

13. A greeting card for mailing consumable products comprising:
a housing defining a receptacle for removably receiving at least one consumable product, said housing including a location for postage, at least one location for an address and a first greeting on an outer surface; and
a wall pivotally secured to the housing, said wall including a second greeting, wherein the wall pivots between an open position and a closed position that conceals the first greeting.

14. The greeting card of claim 13, wherein at least a portion of the wall is substantially transparent.

15. The greeting card of claim 13, wherein the first greeting includes at least one of a text message and an image.

16. The greeting card of claim 13, wherein the second greeting includes at least one of a text message and an image.

17. The greeting card of claim 13, which includes a sleeve having opposing walls and at least one open end, wherein said housing is removably inserted into the opening of the sleeve.

18. The greeting card of claim 17, wherein at least a portion of the sleeve is substantially transparent.

19. A method for providing a greeting to a recipient comprising:
selecting a card that is so constructed and arranged to receive at least one consumable product;
placing a consumable product in the card;
mailing the card to a recipient;
providing a first greeting when the recipient receives the card;
providing a second greeting when the recipient opens a cover pivotally secured to the card;
enabling the recipient to remove the consumable product from the card; and
enabling the recipient to maintain the card in a substantially planar form after removing the consumable product from the card.

20. The method of claim 19, wherein the step of providing the first greeting includes providing at least one of an audio greeting, a visual greeting and an audiovisual greeting.

21. The method of claim 19, wherein the step of providing the second greeting includes providing at least one of an audio greeting, a visual greeting and an audiovisual greeting.

22. The method of claim 19, wherein the step of providing the first greeting includes providing a seasonal greeting.

23. The method of claim 19, wherein the step of providing the second greeting includes providing a seasonal greeting.
